(19) United States
(12) Patent Application Publication
(10) Pub. No.: US 2008/0127290 A1
(43) Pub. Date: May 29, 2008

(54) SERVICE GUIDE FRAGMENTATION METHOD, A SERVER AND A TERMINAL FOR USE IN A RADIO COMMUNICATION NETWORK

(75) Inventors: Gerard Delegue, Cachan (FR); Emmanuel Marilly, Saint-Michel-Sur-Orge (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/772,425

(22) Filed: Jul. 2, 2007

(30) Foreign Application Priority Data
Jul. 3, 2006 (FR) 0652773

(51) Int. Cl. H04N 7/173

(52) U.S. Cl. 725/114

(57) ABSTRACT

The present invention relates to a method of fragmenting service guides providing information on a multimedia content accessible to a terminal (102) by radio communication from a server (100) via a unidirectional network (101) or a bidirectional network (107).

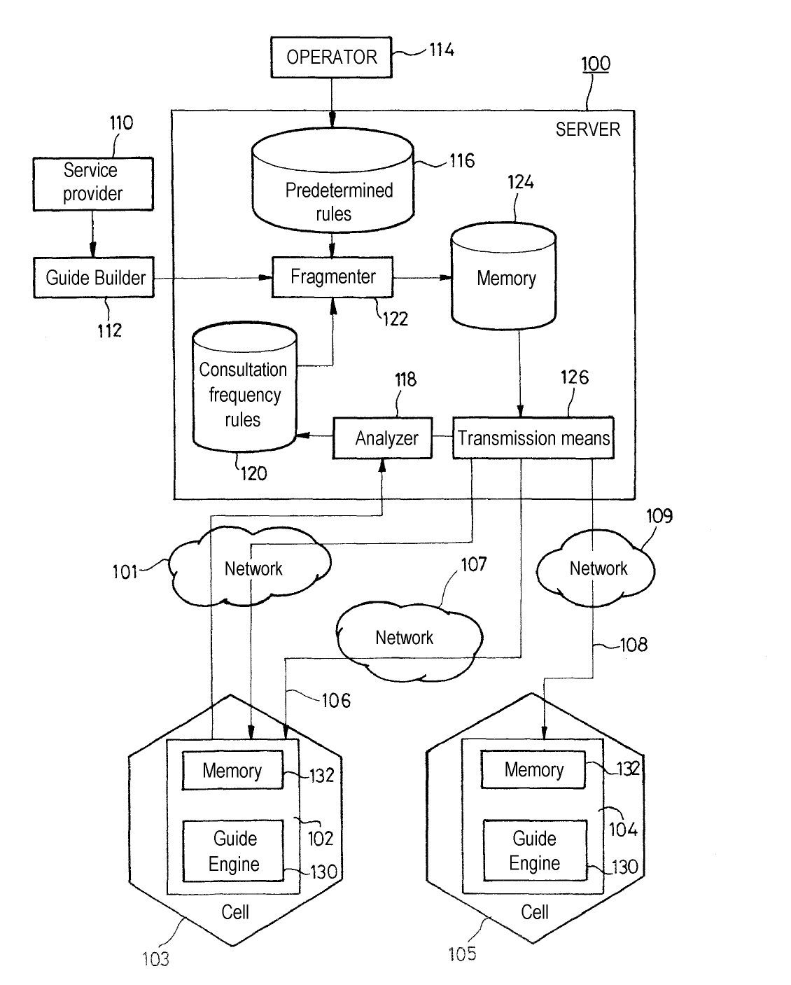

According to the invention, such a method is characterized in that it includes:
a step (118) of analyzing service guide requests sent by the terminal (102);
a step (120) of determining rules of consultation frequency as a function of that analysis; and
a step (122) of fragmenting a service guide using those rules of consultation frequency.

### BACKGROUND OF THE INVENTION

The present invention relates to a service guide fragmentation method, a server and a terminal intended for use in a radio communication network.

In radio communication between a server and terminals in a unidirectional broadcast mode, the server sends radio signals to all terminals situated in its radio broadcast area. This broadcast mode is used by the DMB (Digital Multimedia Broadcast) protocol, the DVB-H (Digital Video Broadcast-Handheld) protocol and the MBMS (Multimedia Broadcast/Multicast Service) protocol, for example.

In radio communication between a server and a terminal in a bidirectional point-to-point mode or unicast mode, the server sends information that is intended solely for one terminal. The radio communication is then two-way, and the terminal also sends to the server. An example of this is radio communication using the UMTS (Universal Mobile Telecommunication System) protocol or the WIMAX (Worldwide Interoperability for Microwave Access) protocol.

In bidirectional or unidirectional radio communication, a server can send two types of information:
A first type of information consists of multimedia contents including pictures, sound, video clips, software, scripts or texts, for example.
A second type of information relates to organizing, presenting or accessing multimedia contents. This second type of information is contained in a service guide (SG). For example, these service guides, also referred to as electronic service guides (ESG) in the prior art, are described in the draft Open Mobile Alliance standard ‘Service Guide For Mobile Broadcast Services’, draft version 1.0 of 15 Feb. 2006, OMA-TS-BCast_ServiceGuide-V1_{—}0_{—}0-20060215-D.

Consider an offer for transmission of video programs broadcast by radio from a server to a mobile terminal: a service guide provides the terminal with information on the programs, such as the scheduled transmission time, a description (for example including text, pictures, a video clip or a program of lower quality), and how to purchase them.

A service guide can also provide a high-level description of a program, generally including its title, the year of its production, its type, its director, the main actors and a summary.

If the service guides are broadcast, the large quantity of data that the server needs to transmit encounters bit rate limitations specific to the radio communication bandwidth concerned. Because of this, unidirectional transmission of service guides employs a looped transmission of the service guides, known as carousel transmission.

That transmission process has the drawback that the terminal user must wait from the time of deciding to consult a given service guide to the time at which the server transmits that service guide.

It is also known in the art to transmit a service guide when, during point-to-point (unicast) radio communication, a terminal requests a server able to provide such service guides to transmit that guide.

In that bidirectional mode, as in the unidirectional mode, the problem then arises of the need to store the service guide in the terminal, because the user can access a service guide faster if the service guide is stored in the memory of the terminal. The larger the service guide, the greater the problem of storing it in that way.

### SUMMARY OF THE INVENTION

The present invention aims to remove one or more of the drawbacks referred to above. It is the result of an observation specific to the invention, namely that it is possible to fragment a service guide containing different information. For example, a service guide containing text and a video clip can be fragmented into two service guide fragments, one containing the text and the other containing the video clip.

Thus the present invention provides a method of fragmenting service guides providing information on a multimedia content accessible to a terminal by radio communication from a server via a unidirectional network or a bidirectional network, characterized in that it includes:
a step of analyzing service guide requests sent by the terminal;
a step of determining rules of consultation frequency of consultation rules as a function of that analysis; and
a step of fragmenting a service guide using those rules of consultation frequency.

The invention automatically fragments service guides using software components and/or hardware components either in a server for sending the service guides or in a terminal for receiving them.

Fragmentation is effected in accordance with rules of consultation frequency representing the interest of the user or users of the terminal concerned in the information contained in the service guide. Thus the invention provides for identifying information of greater interest to that user (or those users) and for personalizing access to the information via the service guide fragments.

If fragmentation is effected in the server, the method may include a step of associating a unidirectional or bidirectional radio communication mode with a service guide fragment.

Service guide fragmentation therefore avoids the unidirectional broadcasting of service guides that are too large or for which there is not much demand.

It reduces the delay necessary for accessing a broadcast service guide since the quantity of information transmitted by the carousel process is reduced by assigning large fragments or fragments that are not frequently consulted by the user to a bidirectional mode.

Finally, by speeding up and personalizing access to a service guide, the method of the invention makes broadcasting multimedia contents more user friendly and attractive, thereby increasing the use of such contents by a user.

In one implementation, two service guide fragments to be transmitted in two different radio communication modes are associated. A terminal receiving these two fragments in the two different radio communication modes can therefore easily combine them.

In one implementation, the server sends a first service guide fragment to the terminal via the unidirectional network, limiting the resulting load on the server compared to broadcasting the whole of the service guide.

Under such circumstances, in one implementation, the server sends a second fragment of the same service guide as the first fragment to the terminal via the bidirectional network. Accordingly, this second fragment is transmitted only if the terminal sends a request to this effect via the bidirectional network, for example.

In one implementation, the service guides are fragmented in accordance with predetermined rules before applying the rules of consultation frequency. For example, these predetermined rules for managing the sending of service guides can be defined by the radio communication network operator.

If fragmentation is effected in the terminal, the terminal can fragment a received service guide in order to store a fragment of that service guide. Thus the use of the memory of the terminal can be optimized and the stored fragment can be accessed quickly.

The invention also provides a radio communication server able to command transmission via a unidirectional network or a bidirectional network of service guides providing information on a multimedia content accessible by radio communication, characterized in that it includes a fragmenter for dividing a service guide as a function of rules of consultation frequency of those services guides.

In one embodiment, in order to determine the rules of consultation frequency, the server includes an analyzer of service guide requests received by the server.

In one embodiment, the server includes means for associating a unidirectional or bidirectional radio communication mode with a service guide fragment.

In one embodiment, the server includes means for associating two service guide fragments to be sent in different radio communication modes.

In one embodiment, the server includes means for transmitting a service guide fragment by radio in either a bidirectional mode or a unidirectional mode.

In one embodiment, the server includes means for fragmenting service guides in accordance with predetermined rules before they are fragmented in accordance with rules of consultation frequency.

The invention also provides a radio communication terminal able to receive via a unidirectional network or a bidirectional network service guides providing information on a multimedia content accessible to the terminal by radio communication, characterized in that it includes means for determining rules based on the frequency of consultation of those service guides by analyzing service guide requests and means for fragmenting a service guide as a function of those rules of consultation frequency.

In one embodiment, the terminal includes means for storing a service guide fragment selected as a function of the frequency of consultation rules.

Finally, the invention also provides a radio communication system including a terminal and a server able to command the transmission via a unidirectional network or a bidirectional network of service guides providing information on a multimedia content accessible to the terminal by radio communication, characterized in that it includes means for determining rules base on the frequency of consultation of those service guides by the terminal and means for fragmenting a service guide as a function of the rules of consultation frequency.

### BRIEF DESCRIPTION OF THE DRAWINGS

Other features and advantages of the invention become apparent in the light of the following description of one implementation of the invention given by way of illustrative and non-limiting example with reference to the appended single FIGURE, which represents a radio communication network employing a method according to the invention.

### DETAILED DESCRIPTION OF THE INVENTION

The method described below with the assistance of the single FIGURE appended to the application represents radio communication between a server 100 and terminals 102 and 104 situated in respective cells 103 and 105 of respective radio communication networks 107 and 109 using a DVB-H protocol to broadcast multimedia contents.

The server 100 sends broadcasts 106 to the terminal 102 and broadcasts 108 to the terminal 104, the content of the broadcasts possibly differing as a function of the cell 103 or 105 concerned.

The server 100 can also send to the terminal 102, which is also in a bidirectional network 101 such as a UMTS network, using a point-to-point transmission mode.

The terminal 102 can therefore receive a service guide relating to a multimedia content from the server 100 in a unidirectional broadcast mode and/or a bidirectional point-to-point mode.

According to the invention, the server 100 and the terminal 102 include means for determining rules based on the frequency of consultation of the service guides by the terminal and means for fragmenting a service guide as a function of those rules of consultation frequency, these means being described in detail below.

Accordingly, if a service guide consists of a plurality of fragments relating to different information concerning a multimedia content, that service guide can be fragmented either in the server 100 or the terminal 102 as a function of stored information regarding access to that information by the terminal 102.

At this stage, it should be noted that although the above description of the invention refers to service guide fragmentation means in the server 100 and in the terminal 102, it is clear that those means could be implemented independently.

A service guide is fragmented in the server 100 in a number of steps:

In a first step, information relating to a multimedia content is grouped together 112 in a service guide by the service provider 110.

These service guide are then transmitted to a service guide fragmenter 122 which can divide a service guide into various fragments in a second step, the fragments obtained in this way being associated with different parameters, such as a radio communication mode or, more precisely, a specific radio communication network, such as a DVB-H broadcast network or a UMTS point-to-point network.

It is equally possible to associate a guide with a sub-element of a network such as a cell 103 or 105, as in the example described.

Service guide are fragmented automatically in accordance with rules 116 predetermined by the radio communication network operator 114. To this end, the predetermined rules can be stored with an indication of the constituents and predefined attributes or information of a guide.

Consider for example a service guide for a multimedia content relating to a movie, this guide containing by way of information a summary in the form of a text, a picture and a video clip such as an advertising banner.

The predetermined rules 116 can then provide for the picture and text portions of the guide to be broadcast whereas, if the user wishes to view the video clip, it is necessary to request it over the point-to-point network. Thus guides requiring a high bandwidth and a high volume of storage in the terminal are no longer a constraint on the broadcasting of service guides via the unidirectional network 107.

These predetermined rules 116 are used to identify the service guides to be fragmented and to fragment them. In the above example, the service guide comprising a summary in the form of a text, a picture and a video clip such as an advertising banner is fragmented into a first fragment comprising the text and the picture, to be broadcast via the unidirectional network 107, and a second fragment comprising the video clip, to be transmitted via the bidirectional network 101.

The predetermined rules 116 can be modified to adapt to new requirements of the operator 114, such as new transmission times. For example, a description of a broadcast may be required in guides broadcast the day before that broadcast is transmitted. To give another example, the operator may define a rule for describing specific service guides, such as pay-per-view service guides.

Fragmentation of service guides also takes into account history rules or rules of consultation frequency 120 that are determined by analyzing access or requests for access to those guides effected by the terminal 102. To this end, the server 100 includes a request analyzer 118 that feeds the base containing the rules 120.

Accordingly, after applying the rules 116 determined by the operator 114, the fragmenter 122 applies the rules of consultation frequency 120. However, it should be noted that a service guide can be broadcast in its entirety instead of being fragmented after application of the predetermined rules 116 or the rules of consultation frequency 120.

To this end, the analyzer 118 includes a service guide model that indicates attributes or information such as the type and name of a content or the name of a guide. For example, for guides written in XML, XML tags can be used to describe this kind of model.

After applying the rules of consultation frequency 120, the fragmenter 122 sends the fragmented or complete service guide to a memory 124 in which service guides are classified according to the bidirectional or unidirectional radio communication mode used for each of them.

This memory 124 thereafter forwards the service guides or service guide fragments to transmission means 126 for transmission in broadcast mode via the network 107 and/or in point-to-point mode via the network 101.

In this example, broadcasting is effected in particular as a function of the geographical location of the terminal, namely a cell 103 or 105 of a DVB-H network. Under such circumstances, the transmission means 126 must identify the network used to transmit a service guide or a service guide fragment before transmission thereof and transmit differently to each of the terminals 102 and 104.

The invention is implemented in the terminals 102 and 104 by a service guide engine 130 that combines broadcast service guides or service guide fragments with service guides or service guide fragments received via the point-to-point network 101 if they relate to the same multimedia content.

Moreover, the terminals 102 and 104 include a memory 132 that remembers the service guides frequently requested by the terminal user. If the size of a service guide is greater than the memory available in the terminal, the memory 132 selects the most pertinent service guide fragments, for example those consulted most frequently or having an optimum size given the storage capacity of the terminal, and stores them within the available memory space.

The memory 132 fragments service guides with the aid of an analysis of access to or requests for access to them. In other words, the memory 132 uses frequency of consultation rules established by the terminal vis-à-vis such access to the service guides or requests for access to them.

A method of the invention can be implemented, for example, according to the draft Open Mobile Alliance standard ‘Service Guide For Mobile Broadcast Services’, draft version 1.0 of 15 Feb. 2006, OMA-TS-BCast_ServiceGuide-V1_{—}0_{—}0-20060215-D, already referred to, or by any other method of radio communication of service guides in broadcast or point-to-point mode, such as the DVB method.

The present invention lends itself to many variants. Thus, in one variant a terminal includes means for displaying an incomplete service guide received in broadcast mode, for example, pending transmission of additional data in bidirectional mode.

In another variant, a terminal user can view on the screen the service guide fragmentation rules applied by the terminal or by the operator, for example in order to modify them.

1. A method of fragmenting service guides providing information on a multimedia content accessible to a terminal (102) by radio communication from a server (100) via a unidirectional network (101) or a bidirectional network (107), characterized in that it includes:
a step (118) of analyzing service guide requests sent by the terminal (102);
a step (120) of determining rules of consultation frequency as a function of that analysis; and
a step (122) of fragmenting a service guide using those rules of consultation frequency.

2. A method according to claim 1 including a step of associating a unidirectional or bidirectional radio communication mode with a service guide fragment in the server (100).

3. A method according to claim 2 including a step of associating two service guide fragments to be transmitted in different radio communication modes.

4. A method according to claim 2 including a step of fragmenting a service guide in accordance with predetermined rules before applying the rules of consultation frequency.

5. A method according to claim 1 including a step of sending a first fragment of the service guide from the server to the terminal via the unidirectional network.

6. A method according to claim 5 including a step of sending a second fragment of the same service guide as the first fragment from the server to the terminal via the bidirectional network.

7. A method according to claim 1 including a step of fragmenting a service guide received by the terminal (102) in order to store a fragment of that service guide in that terminal (102).

8. A radio communication server (100) able to command transmission via a unidirectional network (101) or a bidirectional network (107) of service guides providing information on a multimedia content accessible by radio communication, characterized in that it includes a fragmenter (122) for dividing a service guide as a function of rules of consultation frequency of those service guides.

9. A server (100) according to claim 8 including an analyzer (118) of service guide requests received by the server (100) in order to determine rules of consultation frequency.

10. A server (100) according to claim 8 including means for associating a unidirectional or bidirectional radio communication mode with a service guide fragment.

11. A server (100) according to claim 10 including means for associating two service guide fragments to be transmitted in different radio communication modes.

12. A server (100) according to claim 8 including radio communication means for transmitting a service guide fragment in a bidirectional mode or a unidirectional mode.

13. A server (100) according to claim 8 including means for fragmenting a service guide according to predetermined rules (116) before it is fragmented in accordance with rules of consultation frequency.

14. A radio communication terminal (102) able to receive via a unidirectional network (101) or a bidirectional network (107) service guides providing information on a multimedia content accessible by radio communication, characterized in that it includes means (132) for determining rules based on the frequency of consultation of those service guides by analyzing service guide requests and means for fragmenting a service guide as a function of those frequency of consultation rules.

15. A terminal according to claim 14 including means (132) for storing in the terminal a service guide fragment selected as a function of rules of consultation frequency.

16. A radio communication system including a terminal (102) and a server (100) able to command the transmission via a unidirectional network (101) or a bidirectional network (107) of service guides providing information on a multimedia content accessible to the terminal by radio communication, characterized in that it includes means for determining rules base on the frequency of consultation of those service guides by the terminal and means for fragmenting a service guide as a function of rules of consultation frequency.
